(19) United States
(12) Patent Application Publication
(10) Pub. No.: US 2006/0105663 A1
(43) Pub. Date: May 18, 2006

(54) Polymer assemblies with decorative surfaces

(76) Inventors: Stefan Greulich, Le Grand Saconnex (GE) (DE); Randall Allen Vogel, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/227,521

(22) Filed: Sep. 15, 2005

Related U.S. Application Data
(60) Provisional application No. 60/615,854, filed on Oct. 4, 2004.

(51) Int. Cl. B32B 37/00; B32B 27/12

(52) U.S. Cl. 442/394; 156/308.2

(57) ABSTRACT

A polymer sheet having a decorative surface and a nondecorative surface may be joined to a thermoplastic “substrate” by melt bonding the nondecorative surface and a surface the substrate to different sides of a sheet which has two irregular surfaces. The resulting article is useful for products where a decorative surface on a thermoplastic substrate is desirable, such as automobiles, appliances and power tools.

### CROSS REFERENCE TO RELATED APPLICATION

This application claims the benefit of U.S. Provisional Application No. 60/615,854, filed Oct. 4, 2004.

### FIELD OF THE INVENTION

The present invention relates to a polymer assembly. More particularly, the present invention relates to a polymer sheet having a decorative surface and usually a nondecorative surface may be joined to a thermoplastic “substrate” by melt bonding the nondecorative surface and a surface of the substrate to different sides of a sheet, which has two irregular surfaces.

### BACKGROUND OF THE INVENTION

Thermoplastic polymers (TPs) are important items of commerce, many different types (chemical compositions) and blends thereof being produced for a myriad of uses. One of these uses is a decorative sheet, which has (at least) one decorative surface, which is meant to be viewed. Their main purpose is appearance or ornamentation, and they usually have little or no other functions, such as improving structural soundness, barrier properties, or temperature resistance. These decorative surfaces may be smooth and meant to reflect images with little or no distortion, and/or be shiny, and/or be colored or otherwise decorative in appearance. These decorative sheets in addition may have other desirable properties such as scratch resistance, colorfastness, and weatherability. These decorative sheets may be single layer or multilayer, with each layer contributing various optical, mechanical or appearance properties. If the decorative sheet is a multilayer sheet, oftentimes the various layers are made from the same or nearly the same polymer, so as to avoid problems with adhesion of the various layers to each other. Such structures are known, see for instance U.S. Pat. Nos. 4,931,324, 5,916,643, 5,938,881, 20030055006 and 20020114951, and WO 02/078953, all of which are hereby included by reference.

Oftentimes it is desirable to adhere or bond the decorative layer to a thermoplastic substrate. Usually this thermoplastic substrate is a different thermoplastic polymer than the polymer used in the decorative layer. Although this bonding may be done by a myriad of methods, for instance mechanical fasteners or snap fit fastening, often the simplest and cheapest method is some sort of bonding process. This may involve use of an adhesive, or a compatibilizing adhesive layer, or simply melting the thermoplastics and contacting them with each other while they are melted. In some cases compatibilizing agents may be added to one or more of the TPs to improve such bonding.

However, it is well known that almost all TPs are highly incompatible with one another, and finding an effective adhesive or compatibilizing agent is often daunting, and simply melt bonding to each other almost always doesn't work (i.e. little or no bond strength is obtained). Thus, in many instances simple and inexpensive methods of bonding different TPs, including decorative sheets and substrate thermoplastics, are often not available.

U.S. Pat. No. 4,892,779 describes a multilayer article formed by fusion bonding a microporous polyolefin layer of a specified composition with a nonporous material such as a TP. No mention is made of using the polyolefin layer material to bond two or more different TPs together.

Nonwoven fabrics (NWFs) have also been used to bond other materials together, such as wood and polyethylene, see for instance U.S. Pat. No. 6,136,732 in which a NWF is impregnated with a powdered adhesive which is then bonded to the NWF by melting the adhesive. This sheet may be used to bond “vinyl and/or cloth covering and a variety of surfaces including metal, plastic, rubber and wood” by melting the adhesive on the NWF. However, there is no specific mention of bonding two TPs together.

U.S. Pat. No. 6,544,634 contains an example (i.e. Example 19) in which a rubber is “fused” to the surface of a microporous sheet, this assembly is placed into an injection mold with the uncoated side of the microporous sheet exposed, and propylene is injection molded into the mold. There is no disclosure in this patent of joining two different thermoplastics or a thermoplastic and a thermoset resin.

S. Schwarz, et al, in a paper “Mist™ Technology—A New Approach to Interfacial Adhesion”, given at the 4^{th} International Conference “TPOs in Automotive '97”, October 1997, Novi., Mich., report that polypropylene can be molded to both sides of a microporous sheet. No disclosure is made of using such a sheet to join two different thermoplastics.

U.S. patent application Ser. No. 10/852278 describes the use of polymer sheets having two irregular surfaces to bond two different thermoplastics together by melt bonding each of those thermoplastics to one side of the irregularly surfaced sheet. No mention is made of bonding decorative sheets.

### SUMMARY OF THE INVENTION

Briefly stated, and in accordance with one aspect of the present invention, there is provided an article, comprising, a first sheet comprising a thermoplastic or crosslinked thermoset resin having a first side and a second side, a second sheet made from a first thermoplastic and having a decorative side and a third side wherein said third side is melt bonded to said first side of said first sheet, and optionally a second thermoplastic which is melt bonded to said second side of said sheet, and provided that: said first side and said second side have irregular surfaces; and said first thermoplastic and said second thermoplastic are different.

Pursuant to another aspect of the present invention, there is provided a process for forming an article, comprising: (a) melt bonding a first side of a first sheet comprising a crosslinked thermoset or thermoplastic resin to a third side of second sheet made from a first thermoplastic and having a decorative side and said third side; and (b) optionally melt bonding a second side of said first sheet to a second thermoplastic; provided that: said first side and said second side have irregular surfaces; and said first thermoplastic and said second thermoplastic are different.

Also disclosed herein are processes for forming shaped parts of the article described above, such as thermoforming and “injection cladding” by injection molding a part in which the article above is in the mold before the molten resin is injected.

### DETAILS OF THE INVENTION

The following definitions are provided as reference in accordance with how they are used in the context of this specification and the accompanying claims:

“Sheet” means a material shape in which two of the surfaces have at least about twice, more preferably at least about 10 times, the surface areas of any of the other exterior surfaces. Included in this definition would be a sheet with the dimensions 15 cm×15 cm×0.3 cm thick, and a film 15 cm×15 cm×0.2 mm thick. The latter (which is often called a film) in many instances will be flexible and may be drapeable, so that it can be adapted to conform to irregular surfaces. Preferably the sheet has a minimum thickness of about 0.03 mm, more preferably about 0.08 mm, and especially preferably about 0.23 mm. Preferably the sheet has a maximum thickness of about 0.64 mm, more preferably about 0.38 mm, and especially preferably about 0.25 mm. It is to be understood that any preferred minimum thickness can be combined with any preferred maximum thickness to form a preferred thickness range. In the case of the sheet with a decorative surface, sometimes referred to herein as the second sheet, this sheet may be produced from more than one layer, sheet or film for example. Typically these layers will be laminated or coextruded together to form a single sheet. Preferably the layers of the decorative sheet comprise a clear surface layer over one or more pigmented layers. The sheet layers may be of similar materials to provide ease of processing and interlayer adhesion, or they can be of different materials, in which case they may have viscosities which are similar for processing purposes, and/or have suitable interlayer adhesion. A clear surface layer can provide better durability in appearance when exposed to unfiltered sunlight. Alternatively, particularly for end-use articles not exposed to significant sunlight, a pigmented layer can be used as the surface layer. The pigmented layer should have a combination of sufficient pigment concentration and layer thickness to provide good appearance in applications requiring drawdown or forming of the sheet, which will thin the sheet in areas that are drawn down in the forming process.

“Irregular surface” means that the surface has irregularities in or on it that will aid in mechanically locking to it any molten material, which flows into or onto the surface and the irregularities thereon, and when the molten material subsequently solidifies it causes the material to be mechanically locked (i.e. bonded) to the irregular surface.

“Resin” means any polymeric material, whether of natural or manmiade (synthetic) origin. Synthetic materials are preferred.

“Irregular surface sheet (ISS)” means a sheet having two “irregular surfaces”.

“Melt bonding” means the TP is melted where “melted” means that a crystalline TP is heated to about or above its highest melting point, while an amorphous thermoplastic is melted above its highest glass transition temperature. While melted, the TP is placed in contact with an appropriate surface of the ISS. During this contact, usually some pressure (i.e. force) will be applied to cause the TP to flow onto and perhaps penetrate some of the pores or irregularities on the surface of the ISS. The TP is then allowed to cool, or otherwise become solid.

“Thermoplastic” (TP) is material that is meltable before and while being melt bonded to the ISS, but in their final form are solids, that is they are crystalline or glassy (and therefore typical elastomers, whose melting points and/or glass transition temperature, if any, are below ambient temperature, are not included in TPs, but thermoplastic elastomers are included in TPs). Thus, this can mean a typical (i.e. “classical”) TP polymer such as polyethylene. Preferably the TPs are “classical” TPs, especially the decorative sheet. It can also mean a thermosetting polymer before it thermosets (e.g. crosslinks), that is, while it can be melted and flows in the molten state. Thermosetting may take place after the melt bonding has taken place, perhaps in the same apparatus where the melt bonding took place, and perhaps by simply further heating of the thermoset resin, to form a resin which is glassy and/or crystalline. Useful thermoplastic elastomers include block copolyesters with polyether soft segments, styrene-butadiene block copolymers, and thermoplastic polyurethanes.

By TPs being “different” is meant that they have a different chemical composition. Examples of different thermoplastics include: polyethylene (PE) and polypropylene; polystyrene and poly(ethylene terepithalate) (PET); nylon-6,6 and poly(1,4-butylene terephthalate; nylon-6,6 and nylon-6; polyoxymethylene and poly(phenylene sulfide); poly(ethylene terephthalate) and poly(butylene terephthalate); poly(ether-ether-ketone) and poly(hexafluoropropylene)(perfluoromethyl vinyl ether)copolymer); a thermotropic liquid crystalline polyester and a thermosetting epoxy resin (before crosslinking); and a thermo setting melamine resin (before crosslinking) and a thermo setting phenolic resin (before crosslinking). Different thermoplastics may also include blends of the same thermoplastics but in different proportions, for example a blend of 85 weight percent PET and 15 weight percent PE is different than a blend of 35 weight percent PET and 65 weight percent PE. Also, different includes differing the presence and/or amount of other comonomers, for example PET is different than poly(ethylene isophthalate/terephthalate).

“Bonded” herein is meant the materials are attached to one another, in most instances herein permanently, and/or with the ISS between the materials. Typically, and preferably, no other adhesives or similar materials are used in the bonding process, other than the ISS.

The ISS sheet may have irregular surfaces formed in many ways. It may be: a fabric, for instance woven, knitted or nonwoven; a paper; foamed, particularly an open cell foam and/or a microcellular foam; a sheet with a roughened surface formed by for example sandblasting or with an abrasive such as sandpaper or sharkskin; and a microporous sheet (MPS). Preferred forms of ISS are fabrics, especially nonwoven fabrics (NWFs), and microporous sheets (MPSs).

“Microporous” means a material, usually a thermoset or thermoplastic polymeric material, preferably a thermoplastic, which is at least about 20 percent by volume, more preferably at least about 35% by volume pores. Often the percentage by volume is higher, for instance about 60% to about 75% by volume pores. The porosity is determined according to the equation:
“Porosity”=100(1-d₁/d₂)
wherein d₁ is the actual density of the porous sample determined by weighing a sample and dividing that weight by the volume of the sample, which is determined from the sample's dimensions. The value d₂ is the “theoretical” density of the sample assuming no voids or pores are present in the sample, and is determined by known calculations employing the amounts and corresponding densities of the samples ingredients. More details on the calculation of the porosity may be found in U.S. Pat. No. 4,892,779, which is hereby incorporated by reference. Preferably the microporous material has interconnecting pores.

The MPS herein may be made by methods described in U.S. Pat. Nos. 3,351,495, 4,698,372, 4,867,881, 4,874,568, and 5,130,342, all of which are hereby included by reference. A preferred microporous sheet is described in U.S. Pat. No. 4,892,779, which is hereby included by reference. Similar to many microporous sheets those of this patent have a high amount of a particulate material (filler). This particular type of sheet is made from polyethylene, much of which is a linear ultrahigh molecular weight polymer. “Fabric” is a sheet-like material made from fibers. The materials from which the fibers are made may be synthetic (man-made) or natural. The fabric may be a woven fabric, knitted fabric or a nonwoven fabric, and nonwoven fabrics are preferred. Useful materials for the fabrics include cotton, jute, cellulosics, wool, glass fiber, carbon fiber, poly(ethylene terephthalate), polyamides such as nylon-6, nylon-6,6, and aromatic-aliphatic copolyamides, aramids such as poly(p-phenylene terephthalamide), polypropylene, polyethylene, thermotropic liquid crystalline polymer, fluoropolymers and poly(phenylene sulfide).

The fabric herein can be made by any known fabric making technique, such as weaving or knitting. However a preferred fabric type is a NWF. NWFs can be made by methods described in I. Butler, The Nonwoven Fabrics Handbook, Association of the Nonwoven Fabrics Industry, Cary, N.C., 1999, which is hereby included by reference. Useful types of processes for making NWFs for this invention include spunbonded, and melt blown. Typically the fibers in the NWF will be fixed in some relationship to each other. When the NWF is laid down as a molten TP (for example spunbonded) the fibers may not solidify completely before a new fiber layer contacts the previous fiber layer thereby resulting in partial fusing together of the fibers. The fabric may be needled or spunlaced to entangle and fix the fibers, or the fibers may be thermally bonded together.

The characteristics of the fabric to some extent determines the characteristics of the bond(s) between the TPs to be joined. Preferably the fabric is not so tightly woven that melted TP has difficulty (under the melt bonding condition used) penetrating into and around the fibers of the fabric. Therefore it may be preferable that the fabric be relatively porous. However, if the fabric is too porous it may form bonds, which are too weak. The strength and stiffness of the fabric (and in turn the fibers used in the fabric) may determine to some extent the strength and other properties of the bond(s) formed. Higher strength fibers such as carbon fiber or aramid fibers therefore may be advantageous in some instances.

Without being held to theory, it is believed that the thermoplastics may bond to the surfaces of the ISS sheet (at least in part) by mechanical locking of the TP to the ISS sheet. It is believed that during the melt bonding step the TP “penetrates” the irregularities on the surface, or actually below or through the surface through pores, voids and/or other channels (if they exist). When the TP solidifies, it is mechanically locked into and/or onto these irregularities and, if present, pores, voids and/or other channels.

One type of preferred material for the first and/or second TP is a “classical” TP, that is a material that is not easily crosslinkable, and which has a melting point and/or glass transition temperature above about 30° C. Preferably, if such a classical TP is crystalline, it has a crystalline melting point of 50° C. or more, more preferably with a heat of fusion of 2 J/g or more, especially preferably 5 J/g or more. If the TP is glassy it preferably has a glass transition point of 50° C. or more. In some instances the melting point or glass transition temperature may be so high that the TP decomposes before reaching that temperature. Such polymers are also included herein as TPs. Melting points and glass transition temperatures are measured using ASTM Method ASTM D3418-82. The melting point is taken as the peak of the melting endotherm, and the glass transition temperature is taken at the transition midpoint.

Such classical TPs include: poly(oxymethylene) and its copolymers; polyesters such as PET, poly(1,4-butylene terephthalate), poly(1,4-cyclohexyldimethylene terephthalate), and poly(1,3-poropyleneterephthalate); polyamides such as nylon-6,6, nylon-6, nylon-12, nylon-11, and aromatic-aliphatic copolyamides; polyolefins such as polyethylene (i.e. all forms such as low density, linear low density, high density, etc.), polypropylene, polystyrene, polystyrene/poly(phenylene oxide) blends, polycarbonates such as poly(bispheno-A carbonate); fluoropolymers including perfluoropolymers and partially fluorinated polymers such as copolymers of tetrafluoroethylene and hexafluoropropylene, poly(vinyl fluoride), and the copolymers of ethylene and vinylidene fluoride or vinyl fluoride; polysulfides such as poly(p-phenylene sulfide); polyetherketones such as poly(ether-ketones), poly(ether-ether-ketones), and poly(ether-ketone-ketones); acrylonitrile-styrene acrylate copolymers; poly(etherimides); acryloritrile-1,3-butadinen-styrene copolymers; thermoplastic (meth)acrylic polymers such as poly(methyl methacrylate); thermoplastic elastomers such as the “block” copolyester from terephthalate, 1,4-butanediol and poly(tetramethyleneether)glycol, and a block polyolefin containing styrene and (hydrogenated) 1,3-butadiene blocks; and chlorinated polymers such as poly(vinyl chloride), vinyl chloride copolymer, ionomers such as copolymers of ethylene, (meth)acrylic acid, and optionally other comonomers in which some of the carboxylic acid groups have been converted to metal carboxylates, and poly(vinylidene chloride), and blends thereof. Polymers which may be formed in situ, such as (meth)acrylate ester polymers are also included. Any of the types of TPs in this listing may be joined with any other type of TP in this listing in the process described herein, to make a preferred assembly. Polymer from a single type (for example the polyolefins polyethylene and polypropylene) may be joined together in the instant process, as long as the two polymers are chemically distinct. In one form, it is preferred that one or both of the first and second TPs are classical TPs.

For the decorative sheet preferred types of surface layer polymers are ionomers, poly(vinylidene fluoride), polycarbonates, acrylonitrile/styrene/acrylate (ASA) copolymers, and acrylonitrile-butadiene-styrene (ABS) copolymers. Ionomers are particularly preferred for this use. Useful ionomers include copolymers of ethylene and (meth)acrylic acid and optionally other monomers, such as (meth)acrylate esters, for example n-butyl acrylate, ethyl acrylate, and isobutyl acrylate, and preferred ionomers are copolymers of ethylene and having a comonomer content between 8-25% by weight, based on the weight of the copolymer, the comonomer being a C₃-C₈ α,β-ethyleneically unsaturated monocarboxylic acid, with at least 30% of the carboxylic acid moieties in the copolymer neutralized with metal ions, preferably a mixture of metal ions to provide enhanced clarity and surface properties to the surface polymeric layer. More preferred copolymers have a comonomer content of about 10-20% by weight with at least 40% of the acid moieties neutralized with metal ions. Useful metals cations include Na⁺, Zn⁺⁺, Ca⁺⁺, Mg⁺⁺, and Li⁺, and combinations thereof.

The decorative sheet may contain more than one layer. For example there may be a pigmented layer which provides color and/or design to the sheet, and an outer layer (the outer layer is the layer closest to the observer when viewed) which is clear and which may protect the sheet from scratches or other damage, especially to its appearance. In some instances preferably the surface layer has high gloss. The pigmented layer may contain one or more of pigments, dyes, coloring agents, and metal and other types of flake material, in addition to other components usually found in thermoplastics. Especially for decorative sheet exposed to unfiltered sunlight, additives and stabilizers can be added to the surface and underlayers to improve weathering durability. Additives normally compounded into plastics or added to coating compositions may be included in the first and underlayers of the co-extruded polymeric layers as required for the end use of the resulting product that is formed, i.e., automotive or truck part or panel or laminates or films. These requirements and the additives needed to meet these requirements are well known to those skilled in the art. Typical of the materials that are often desirable are, for example, UV absorbers, UV hindered amine light stabilizers, antioxidants and thermal stabilizers, processing aids, pigments and the like. When included, these components are preferably present in amounts of about 0.5 to about 3.0 (preferably about 1.0 to about 2.0) parts per hundred parts by weight of the polymeric material but may be present in lower or higher amounts.

Of particular importance if the part is to be exposed to ultraviolet (UV) light, as is present in sunlight, is the inclusion of one or more UV stabilizers and/or absorbers for the ionomer. Typical UV stabilizers are hindered amine light stabilizers, such as bis(1,2,2,6,6 pentamethyl-4-piperidinyl sebacate) and di[4(2,2,6,6,tetramethyl piperidinyl)]sebacate, poly[[6-[1,1,3,3-tetramethylbutyl]amino-s-triazine-2,4-diyl][(2,2,6,6-tetramethyl-4-piperidyl)imino]hexamethylene[(2,2,6,6-tetramethyl-4-piperidyl)iminol]], Chimassor® 2020 1,6-hexanediamine, N,N′-bis(2,2,6,6-tetramethyl 1-4-piperidyl)-, polymer with 2,4,6-trichloro-1,3,5-triazine, reaction products with N-butyl-1-butanamine and N-butyl-2,2,6,6-tetramethyl-4-piperidinamine, Tinuvin® NOR 371, a triazine derivative and any mixtures thereof.

Typically useful UV absorbers include: benzophenones such as hydroxy dodecyloxy benzophenone, 2,4-dihydroxybenzophenone, hydroxybenzophenones containing sulfonic groups and the like; triazoles such as 2-phenyl-4-(2′,2′-dihydroxylbenzoyl)-triazoles; substituted benzothiazoles such as hydroxyphenylthiazoles and the like; triazines, such as, 3,5-dialkyl-4-hydroxyphenyl derivatives of triazine, sulfur containing derivatives of dialkyl-4-hydroxy phenyl triazines, hydroxy phenyl-1,3,5-triazine and the like; benzoates, such as, dibenzoate of diphenylol propane, tertiary butyl benzoate of diphenylol propane and the like; and others, such as, lower alkyl thiomethylene containing phenols, substituted benzenes such as 1,3-bis-(2′-hydroxybenzoyl)benzene, metal derivatives of 3,5-di-t-butyl-4-hydroxy phenyl propionic acid, asymmetrical oxalic acid, diarylarides, alkylhydroxy phenyl-thioalkanoic acid ester, and hindered amines of bipiperidyl derivatives.

Preferred UV absorbers and hindered amine light stabilizers, all available from Ciba Geigy, are TINUVIN®.234 (2-(2H-benzotriazol-2-yl)-4,6-bis(1-methyl-1-phenylethyl)phenol), TINUVIN® 327 (2-(3′,5′-di-tert-butyl-2′-hydroxyphenyl)-5 chlorobenzotriazole), TINUVIN® 328 (2-(2′hydroxy-3′,5′-di-tert-amylphenyl)benzotriazole), TINUVIN® 329 (2-(2′-hydroxy-5′-tert-octylphenyl)benzotriazole), TINUVIN® 765 (bis(1,2,2,6,6-pentamethyl-4-piperidinyl)sebacate), TINUVIN® 770 (bis(2,2,6,6-tetramethyl-4-piperidinyl) decanedioate), and CHIMASSORB® 944 (N,N-bis(2,2,6,6-tetramethyl-4-piperidinyl)-1,6-hexanediamine polymer with 2,4,6-trichloro-1,3,5-triazine and 2,4,4-trimethyl-1,2-pentanamine.

Preferred thermal stabilizers, all available from Ciba Geigy, are IRGANOX® 259 (hexamethylene bis(3,5-di-tert-butyl-4-hydroxyhydrocinnamate), IRGANOX® 1010 (3,5-bis(1,1-dimethylethyl)-4-hyroxybenzenepropanoic acid, 2,2-bis[[3-[3,5-bis(1,1-dimethylethyl)-4-hydroxyphenyl]-1-oxopropoxy]methyl]1,3-propanediyl ester), IRGANOX® 1076 (octadecyl 3,5-di-tert-butyl-4-hydroxyhydrocinnamate), Iragnox® 1098 (N,N-hexamethylene bis(3,5-di-tert-butyl-4-hydroxyhydrocinnamamide), IRGANOX® B215 (33/67 blend of IRGANOX® 1010 with tris(2,4-di-tert-butylphenyl)phosphite), IRGANOX® B225 (50/50 blend of IRGANOX® 1010 with tris(2,4-di-tert-butylphenyl)phosphite), and IRGANOX® B1171 (50/50 blend of IRGANOX® 1098 with tris(2,4-di-tert-butylphenyl)phosphite).

Pigments include both clear pigments, such as inorganic siliceous pigments (silica pigments, for example) and conventional pigments. Conventional pigments include metallic oxides, such as, titanium dioxide, and iron oxide; metal hydroxides; metal flakes such as aluminum flake; chromates, such as, lead chromate; sulfides; sulfates; carbonates; carbon black; silica; talc; china clay; phthalocyanine blues and greens, organo reds; organo maroons and other organic pigments and dyes. Particularly preferred are pigments that are stable at high temperatures. Pigments are generally formulated into a millbase by mixing the pigments with a dispersing resin that may be the same as or compatible with the material into which the pigment is to be incorporated. Pigment dispersions are formed by conventional means such as sand grinding, ball milling, attritor grinding or two-roll milling. Other additives, while not generally needed or used, such as fiber glass and mineral fillers, anti-slip agents, plasticizers, nucleating agents, and the like, can be incorporated.

This two-layer type of decorative sheet may also imitate the effect of so-called base coat-clear coat finishes used in certain industries, such as automobile manufacturing. In previous decorative sheets additional layers “behind” the pigmented layer were often usually present to provide adhesion to the substrate to which the decorative sheet was to be adhered. For example behind thereat pigmented layer there would be a so-called tie layer or adhesive layer, and bonded to that would be another (4^{th}) layer, usually of the same or a similar polymer which the substrate was made of. The tie or adhesive layer had to be chosen carefully for each type of 4^{th} layer polymer, and adhesion (e.g. bonding) was sometimes not as good as desired. For more information on decorative sheets see U.S. Pat. No. 4,931,324, 5,916,643, 5,938,881, 20030055006 and 20020114951, and WO 02/078953, all of which have previously been included by reference.

In the present invention, in a sense, the ISS takes the place of the tie layer, and a 4^{th} layer is not needed. The other side of the ISS may be bonded directly to the substrate, and usually good bonds are obtained. In some instances substrates may be made of polymers that were difficult or impossible to use previously since adhesion to those polymers was difficult at best. A single type of ISS may be used for most substrates, so manufacturing and inventory of the final product is simplified over a product line. Lack of a tie or adhesive layer may also lead to process simplifications (for example, fewer extruders needed) and lower process energy needs.

The decorative sheet may be bonded to many different types of thermoplastics (substrate), for instance a polyolefin (especially polyethylene and its copolymers, polypropylene and its copolymers, and polystyrene), a poly(meth)acrylate [especially poly(methyl methacrylate)], a polycarbonate, a fluorinated polymer (especially perfluoropolymers), a polyester [especially poly(ethylene terephthalate), poly(1,3-propylene)terephthalate), poly(1,4-butylene terephthalate), poly(l,6-cychexylenendimethanol terephthalate), and poly(ethylene 1,6-napthalate)], and copolymers of all of these], a polyamide (especially nylon 6,6, nylon-6, and poly(1,4-phenylene terephthalamide), and copolymers of any of these], a thermotropic liquid crystalline polymer, a polysulfone, poly(oxymethylene) homo- and copolymers, a polysulfide, a polyketone (including polyketones containing ether linking groups), an acrylonitrile-butadiene-styrene (ABS) copolymer, a chlorinated polymer [especially poly(vinyl chloride) and poly(vinylidene chlbride)], or a thermoplastic elastomer, especially a thermoplastic block co(polyester-polyether), a block copolyolefin, a thermoplastic urethane or a thermoplastic elastomeric polymer blend.

The articles of the present invention may be made by many methods, and some of these are outlined below and in the examples. If the decorative sheet is a single layer it may be extruded and upon extrusion the undecorated (third side above) of the sheet is laminated to the ISS. Alternatively, the decorative sheet may simply be hot roll laminated to the ISS in a separate step.

If the decorative sheet is more than one layer the layers may be coextruded and joined during that process in the correct order. After the coextrusion the ISS may be laminated to the far side of the decorative sheet. Alternatively, the layers of the decorative sheet may laminated together and the ISS may be laminated to the decorative sheet, after the decorative sheet has been laminated together, or simultaneously with the lamination of the decorative sheet layers, or the ISS may first be laminated to the “rear” layer of the decorative sheet which then may be laminated to the other layers of the decorative sheet.

The substrate to which the second side of the ISS is bonded may be attached during any of the processes described above, as by laminating to the ISS is either simultaneously, before or after the ISS is bonded to the decorative sheet.

Other processes may also be used. For the example the decorative sheet, or its constituent layers, the ISS and the substrate may be placed in a thermoforming machine, and while these layers are being thermoformed they may also be laminated/melt bonded together assuming sufficient heat is applied to the various layers. Alternatively, the decorative and ISS already melt bonded together may be placed into the thermoforming machine with the substrate and the substrate melt bonded to the ISS while a shaped part is being formed. Of course the fully assembled article which comprises the decorative sheet, ISS and substrate, in the form of a sheet may also be thermoformed. An article comprising these components includes such sheets, whether thermoformed or not.

In a method somewhat analogous to thermoforming, the decorative sheet melt bonded to the ISS may be placed in an injection or compression mold with the ISS third side facing into the mold cavity, and molten thermoplastic injected into the mold to melt bond it to the third side of the ISS. This method is applicable to both injection and compression molding, and may sometimes be called “injection cladding”. This forms a part which has a decorative surface but which may be thicker or a more complex shape than that usually obtained by thermoforming. The injected thermoplastic may be a “classical” thermoplastic or an uncured thermosetting resin which may be allowed to cure (crosslink) in the mold or be crosslinked after solidifying and removal from the mold. In this type of process preferably the layer of the decorative sheet are not completely melted. They may be cooled by the mold wall which they are in contact with, so even though the melt temperature of the molten thermoplastic may be higher than the melting point of the decorative sheet polymer(s), a satisfactory part, often with high glass, may be obtained.

Other forming processes such as blow molding or rotational molding to form hollow objects, bottles for instance, may also be used.

In the melt bonding process it is preferred that the rough surface features, whatever they are, of the ISS are not usually totally destroyed, and are often left fairly intact. For instance if the ISS comprises a TP, and temperature of the melt bonding process results in that TP being melted, the irregularities of the ISS may be lost. This may be avoided by a number of methods. The temperatures needed to cause the decorative sheet and/or substrate to melt may be low enough so that the melting point (if any) and/or the glass transition point of any TP comprising the ISS is higher than the melt bonding process temperature. Another method for avoiding loss of surface irregularities is for the ISS to be made from a crosslinked thermoset resin or another material with a high melting point, such as a metal. If the ISS comprises a TP, in some instances the TP may be so viscous that it flows little if at all above its melting/glass transition temperature. The viscosity can be increased by using a large amount of filler, and/or using a TP which has a very high molecular weight, such as ultrahigh molecular weight polyethylene. For example, in one type of preferred ISS, preferably MPS, made from a thermoplastic, it is preferred that the thermoplastic have a weight average molecular weight of about 500,000 or more, more preferably about 1,000,000 or more. One useful type of TP which can be obtained in such high molecular weights is polyethylene, and it is a preferred TP for the ISS, preferably MPS. Another method to prevent the loss of rough surface features when bonding (a) TP(s) with higher melting points or glass transition temperatures is to minimize the time of exposure of the ISS to higher temperatures, so that the TP(s) “penetrate” the rough surface in a short period of time, which is not enough time for heat transfer to cause loss of the rough surface. Some of these methods may be combined to further retard loss of surface irregularities in the ISS.

Once the bonded structure is formed, in many instances the bonded interfaces are not the weak point in the structure. That is, in many instances attempts to peel the two TPs from each other (TPs in the sense of during the melt bonding process) results in cohesive failure of one of the TPs or ISS, illustrating that a material's inherent strength is the weak point of the bonded assembly.

The polymers described herein, either the TPs and/or the polymers of the ISS, but particularly the TPs, may contain materials normally found in such polymers, for example, fillers, reinforcing agents, antioxidants, pigments dyes, flame retardants, etc., in the amounts that are normally used in such compositions.

As noted above, the decorative sheets may have certain optical or appearance properties in use. For example, they may be shiny (reflective and/or glossy) or have mirror-like optical properties in reflecting images. These properties can often be measured by certain tests. Other properties may also be important, such as scratch resistance. Some of these are described below, and they are applicable to the assembly which comprises the decorative layer and ISS, and also the assembly which comprises the decorative layer, the ISS and the substrate.

The articles described herein are useful as intermediates for or components of various types of products made of thermoplastics that desirably have decorative surfaces of some type, such as automobiles or automobile components such as body panels (quarter panels, hoods, trunk lids, roofs, bumpers, dashboards, interior panels, interior trim parts, gas caps, and wheel covers) appliances including components such as lids, covers, bodies, and panels, power tool housings, boxes and housings for various electronic products such as computers, keyboards, monitors, printers, television sets, radios, telephones including portable and cell phones, toys, furniture, sporting goods such as skis, snowboards, skate boards, shoes and boots, buckles, and bindings, etc., cosmetic articles like perfume bottles or other containers for cosmetic articles, and other consumer products such as lighters, pens. This method may also be used to securely bond a distinctive colored layer to plastic articles that may be counterfeited such as poker or casino chips or identification cards.

Distinctness of Image (DOI). This measurement was made using the AutoSpect Paint Appearance Quality Measurement System (QMS), available from Perceptron, Plymouth, Mich. 48170, USA. This is measured on the decorative surface. It is preferred that it have a value of about 60 or more, more preferably about 75 or more.

Gloss, measured by ASTM Method 284 as, η-angular selectivity of reflectance, involving surface reflected light, the degree to which reflected highlights or images of objects may be superimposed on a surface. Sixty degree gloss should preferably be greater than 70%, more preferably greater than 85%.

Haze, measured ASTM Method 284 as: η-scattering of light at the glossy surface of a specimen responsible for the apparent reduction in contrast of objects viewed by reflection from the surface.

There is an automotive weathering protocol, SAE J1960. Preferably residual gloss after 2500 KJ of weathering exposure {[(initial gloss-weathered gloss)/initial gloss]×100} is greater than about 80%. Also preferably the L,a,b color change should be less than “2.5 delta E”.

In the (Comparative) Examples, the following abbreviations and materials are used:

MiST® SP700 and SP1400—a microporous sheet containing high molecular weight polyethylene and large amounts of precipitated silica available from PPG Industries, Pittsburgh, Pa., USA.

Hifax® 387—a polypropylene available from Basell North America, Inc., Elkton, Md. 21921 USA.

The following are all available from E.I. DuPont de Nemours & Co. Inc., Wilmington, Del. 19898 USA:

Delrin® 511 P—a medium viscosity acetal homopolymer.

Delrin 525GR—a medium viscosity acetal homopolymer containing 25% glass reinforcement.

Crastin® SK605—a poly(1,4-butylene terephthalate) containing 30% glass reinforcement.

Zytel®101—nylon-6,6, not reinforced.

Zytel CDV805—a nylon-6,6 which is glass reinforced, toughened and is electrically conductive.

Surlyn® 9910 ionomer—an ethylene/methacrylic acid copolymer partially neutralized with zinc ions having a specific gravity of 0.97 and a melt flow index of 0.7.

### EXAMPLES 1-2

A 3-layer laminate was prepared by extruding two layers of Surlyr® 9910 ionomer on a Sano multiextruder coextrusion line. One of these layers, which was 250 μm thick was (optically) clear and colorless, and the other layer was pigmented red using 6-8 weight percent of a red color concentrate in Surlyn® 9910, and was 300 μm thick. The two Surlyn layers were laminated together and the red pigmented layer was laminated to MiST® SP700 (175 μm thick) to form Laminate A, or MiST® SP1400 (350 μm thick) to form Laminate B. The lamination was carried out by forming the two Surlyn layers through a coat hanger die and before they went through a pair of nip rolls, the MiST film was brought into contact with the pigmented Surlyn layer. The nip rolls pressed the molten ionomer onto the MiST film, bonding to the pigmented Surlyn layer which presumably was still somewhat molten while passing though the rolls. Both Laminates A and B were so well laminated together that it was impossible to peel the layers apart.

### Example 3

Laminate A was vacuum thermoformed in a thermoforming machine at about 120° C. (polymer surface temperature). The mold was at ambient temperature. The part formed was a shallow pan 13.5 cm'9.5 cm×2.5 cm deep. The thermoformed Laminate A, now called Laminate C, could not be peeled apart. For the injection molding Examples 4-17, where Laminate C was used, the bottoms were cut out of the pans and used.

### EXAMPLES 4-17

Two different molds were used for these examples. Mold 1 was center gated disc mold, the cavity being 12.5 cm in diameter and 2.5 cm deep. Mold 2 was a plaque mold 5×13 cm and 3 cm deep.

The laminate was placed into the mold with the clear Surlyn layer adhered to the mold wall using an adhesive, so the MiST side of the laminate faced the mold cavity. The thermoplastic was then injected into the mold, using injection molding conditions (temperature, pressure, mold cycle time) typical for that particular thermoplastic. It was attempted to measure peel strength, but in most instances the MiST layer could not be separated from the thermoplastic. Where it could be separated, the peel strength is given. Results are shown in Table 1.

TABLE 1

| | | | | peel strength |
|---|---|---|---|---|
| Example | Laminate | Thermoplastic | Mold | [lb/in] |
| 4 | A | Delrin ® 511P | 1 | — |
| 5 | A | Delrin ® 525GR | 1 | 23 |
| 6 | A | Crastin ® SK605 | 1 | — |
| 7 | B | Crastin ® SK605 | 1 | — |
| 8 | A | Zytel ® CDV805 | 1 | 29 |
| 9 | A | Hifax ® 387 | 1 | — |
| 10 | A | Delrin ® 525GR | 2 | — |
| 11 | A | Crastin ® SK605 | 2 | — |
| 12 | A | Zytel ® 101 | 2 | — |
| 13 | A | Zytel ® CDV805 | 2 | — |
| 14 | C | Delrin ® 525GR | 2 | 5.3 |
| 15 | C | Crastin ® SK605 | 2 | 15 |
| 16 | C | Zytel ® 101 | 2 | — |
| 17 | C | Zytel ® CDV805 | 2 | 29 |

It is therefore, apparent that there has been provided in accordance with the present invention, an article and process for polymer assemblies with decorative surfaces that fully satisfies the aims and advantages hereinbefore set forth. While this invention has been described in conjunction with a specific embodiment thereof, ot is evident that many alternatives, modifications, and variations will be apparent to those skilled in the art. Accordingly, it is intended to embrace all such alternatives, modifications and variations that fall within the spirit and broad scope of the appended claims.

What is claimed is:

1. An article, comprising, a first sheet comprising a thermoplastic or crosslinked thermoset resin having a first side and a second side, a second sheet made from a first thermoplastic and having a decorative side and a third side wherein said third side is melt bonded to said first side of said first sheet, and optionally a second thermoplastic which is melt bonded to said second side of said sheet, and provided that:
said first side and said second side have irregular surfaces; and
said first thermoplastic and said second thermoplastic are different.

2. The article as recited in claim 1 wherein said first sheet is a nonwoven fabric or a microporous sheet.

3. The article as recited in claim 1 wherein said first sheet is a microporous sheet which comprises polyethylene with a weight average molecular weight of about 500,000 or more.

4. The article as recited in claim 1 wherein said first thermoplastic and said second thermoplastic are both classical thermoplastics.

5. The article as recited in claim 4 wherein said first thermoplastic and said second thermoplastic are selected from the group consisting of poly(oxymethylene) and its copolymers; polyesters, polyamides, polyolefins, polystyrene/poly(phenylene oxide) blends, polycarbonates, fluoropolymers, polysulfides, polyetherketones, acrylonitrile-1,3-butadinene-styrene copolymers, acrylonitrile- styrene-acrylate copolymers, thermoplastic (meth)acrylic polymers, thermoplastic elastomers, chlorinated polymers, ionomers, and blends thereof.

6. The article as recited in claim 1 wherein said decorative side of said second sheet comprises a polymer selected from the group consisting of ionomers, poly(vinylidene fluoride), polycarbonates, acrylonitrile-styrene-acrylate copolymers, and acrylonitrile-butadiene-styrene copolymers.

7. The article as recited in claim 1 wherein said second sheet comprises more than one layer.

8. The article as recited in claim 7 wherein said decorative side of said second sheet has a clear outer layer and beneath said clear outer layer is a colored layer.

9. The article as recited in claim 1 wherein said second sheet comprises one or both of a UV stabilizer, a UV absorber, or both.

10. A device selected from the group consisting of an automobile component, an appliance, a power tool housing, a box or housing for an electronic product, a toy, a piece of furniture, an item for sports, a container for cosmetics or cosmetic articles, a lighter, or a pen comprising the article of claim 1.

11. A device as recited in claim 10, wherein the automobile component is or is part of a body panel, a quarter panel, a hood, a trunk lid, a roof, a bumper, a dashboard, an interior panel, an interior trim part, a gas cap, or a wheel cover.

12. A process for forming an article, comprising:
(a) melt bonding a first side of a first sheet comprising a crosslinked thermoset or thermoplastic resin to a third side of second sheet made from a first thermoplastic and having a decorative side and said third side; and
(b) optionally melt bonding a second side of said first sheet to a second thermoplastic;
provided that:
said first side and said second side have irregular surfaces; and
said first thermoplastic and said second thermoplastic are different.

13. The process as recited in claim 12 wherein said first sheet is a nonwoven fabric or a microporous sheet.

14. The process as recited in claim 12 wherein said first thermoplastic and said second thermoplastic are both classical thermoplastics.

15. The process as recited in claim 14 wherein said first thermoplastic and said second thermoplastic are selected from the group consisting of poly(oxymethylene) and its copolymers; polyesters, polyamides, polyolefins, polystyrene/poly(phenylene oxide) blends, polycarbonates, fluoropolymers, polysulfides, polyetherketones, acrylonitrile-1,3-butadinene-styrene copolymers, acrylonitrile- styrene-acrylate copolymers, thermoplastic (meth)acrylic polymers, thermoplastic elastomers, chlorinated polymers, ionomers, and blends thereof.

16. The process as recited in claim 12 wherein said decorative side of said second sheet comprises a polymer selected from the group consisting of ionomers, poly(vinylidene fluoride), polycarbonates, acrylonitrile-styrene-acrylate copolymers, and acrylonitrile-butadiene-styrene copolymers.

17. The process as recited in claim 12 wherein said second sheet comprises more than one layer.

18. The process as recited in claim 17 wherein said decorative side of said second sheet has a clear outer layer and beneath said clear outer layer is a colored layer.

19. The process as recited in claim 12 wherein said melt bonding is carried out by lamination, thermoforming, injection molding, and blow molding, or a combination thereof.

20. The process as recited in claim 17 wherein said second layer is formed by lamination and optionally said first side and said second side are also melt bonded by lamination.

21. The process as recited in claim 12 wherein said first side and said second side are melt bonded by lamination.

22. A device selected from the group consisting of an automobile component, an appliance, a power tool housing, a box or housing for an electronic product, a toy, a piece of furniture, an item for sports, a container for cosmetics or cosmetic articles, a lighter, or a pen made by a process comprising the process of claim 12.

23. A device according to claim 22, wherein the automobile component is or is part of a body panel, a quarter panel, a hood, a trunk lid, a roof, a bumper, a dashboard, an interior panel, an interior trim part, a gas cap, or a wheel cover.
